(19) United States
(12) Patent Application Publication
(10) Pub. No.: US 2024/0005391 A1
(43) Pub. Date: Jan. 4, 2024

(54) BATTERY RENTAL SYSTEM, BATTERY RENTAL METHOD, AND STORAGE MEDIUM

(71) Applicant: Toyota Jidosha Kabushiki Kaisha, Toyota-shi Aichi-ken (JP)

(72) Inventors: Atsushi HANAWA, Miyoshi-shi Aichi-ken (JP); Makoto HOTTA, Toyota-shi Aichi-ken (JP); Keita ASAKURA, Okazaki-shi Aichi-Ken (JP); Satoshi KUGE, Toyota-shi Aichi-ken (JP)

(73) Assignee: Toyota Jidosha Kabushiki Kaisha, Toyota-shi Aichi-ken (JP)

(21) Appl. No.: 18/199,704

(22) Filed: May 19, 2023

(30) Foreign Application Priority Data
Jul. 4, 2022 (JP) 2022-107862

(51) Int. Cl. G06Q 30/0645; B60L 58/13

(52) U.S. Cl. CPC G06Q 30/0645; B60L 58/13; B60L 2240/60; B60L 2260/52; B60L 2260/54

(57) ABSTRACT

A battery rental system includes: a communication unit that acquires information on a destination of an electrified vehicle; an estimation unit that estimates energy required for the electrified vehicle to reach the destination; and a selection unit that selects a battery trailer to be rented to the electrified vehicle from a plurality of battery trailers based on the estimated required energy.

### CROSS-REFERENCE TO RELATED APPLICATION

This application claims priority to Japanese Patent Application No. 2022-107862 filed on Jul. 4, 2022, incorporated herein by reference in its entirety.

### BACKGROUND

### 1. Technical Field

The present disclosure relates to battery rental systems, battery rental method, and storage medium.

### 2. Description of Related Art

Japanese Patent No. 5113950 (JP 5113950 B) discloses a battery trailer system for renting a battery trailer that is detachably connected to an electrified vehicle.

### SUMMARY

In JP 5113950 B, however, there are cases where a battery trailer that is not appropriate for the energy required for an electrified vehicle is rented. Specifically, there are cases where a battery trailer whose remaining capacity is too large for the energy required for an electrified vehicle is rented. It is therefore desired to rent a battery trailer (battery) whose remaining capacity is appropriate for the energy required for an electrified vehicle.

It is an object of the present disclosure to provide a battery rental system capable of renting a battery whose remaining capacity is appropriate for the energy required for an electrified vehicle.

A battery rental system according to one aspect of the present disclosure is a battery rental system for renting to an electrified vehicle at least one of a plurality of batteries that supplies power to the electrified vehicle. The battery rental system includes: an acquisition unit that acquires information on a destination of the electrified vehicle; an estimation unit that estimates energy required for the electrified vehicle to reach the destination; and a selection unit that selects a battery to be rented to the electrified vehicle from a plurality of batteries based on the estimated required energy.

In the battery rental system according to the one aspect of the present disclosure, as described above, a battery to be rented to the electrified vehicle is selected based on the estimated value of the energy required to reach the destination. This configuration reduces the possibility that a battery whose remaining capacity is too large for the estimated required energy is selected. It is therefore possible to rent a battery whose remaining capacity is appropriate for the energy required for the electrified vehicle.

In the battery rental system according to the one aspect of the present disclosure, the plurality of batteries may include a first battery and a second battery, a sum of a remaining capacity of the electrified vehicle and a remaining capacity of the first battery is may equal to or larger than the required energy, and the second battery may has a larger remaining capacity than the first battery. The selection unit may selects the first battery as the battery to be rented to the electrified vehicle when the first battery and the second battery are available for rent. With this configuration, the second battery having a larger remaining capacity than the first battery can be prevented from being selected. Therefore, the second battery can be rented to a user who needs the second battery.

In the battery rental system according to the one aspect of the present disclosure, the estimation unit may estimates the required energy based on at least a travel route to the destination by using big data, the big data being a collection of a plurality of pieces of data on a relationship between a traveling state and traveling environment of the electrified vehicle and power required for traveling. With this configuration, the energy required to travel along the travel route to the destination can be more accurately estimated using the big data.

In this case, the estimation unit may calculates the travel route to the destination that requires less power consumption based on the big data, and estimates the required energy when the electrified vehicle travels along the travel route that requires less power consumption. With this configuration, the travel route to the destination that requires less power consumption can be more accurately calculated using the big data. As a result, the estimated required energy can further be reduced.

In the battery rental system according to the one aspect of the present disclosure, the electrified vehicle may includes a hybrid electric vehicle equipped with an engine. The destination may includes an exit of a controlled area where exhaust emissions are controlled. The estimation unit may estimates energy required for the electrified vehicle to travel along a travel route from an entrance of the controlled area to the exit of the controlled area. The selection unit may selects, based on the estimated required energy, the battery to be rented to the electrified vehicle from the plurality of batteries that are available for rent at the entrance. Since exhaust emissions are controlled in the controlled area, the electrified vehicle more frequently uses electric power to travel in the controlled area. As a result, power consumption of the electrified vehicle in the controlled area is relatively large. Therefore, selecting a battery based on the energy required to travel along the travel route in the controlled area reduces the possibility that the battery of the electrified vehicle runs out in the controlled area.

In the battery rental system according to the one aspect of the present disclosure, the selection unit may selects at least one of a plurality of self-propelled or towable battery trailers based on the estimated required energy. According to the present disclosure, it is possible to rent a battery trailer whose remaining capacity is appropriate for the energy required for the electrified vehicle.

In the battery rental system according to the one aspect of the present disclosure, the selection unit may selects, based on the estimated required energy, at least one of a plurality of battery devices configured to be loaded on the electrified vehicle. According to the present disclosure, it is possible to rent a battery device whose remaining capacity is appropriate for the energy required for the electrified vehicle.

According to the present disclosure, it is possible to rent a battery whose remaining capacity is appropriate for the energy required for an electrified vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of a battery rental system according to an embodiment;

FIG. 2 shows an electrified vehicle and a battery trailer according to the embodiment;

FIG. 3 shows a detailed configuration of a system for power transfer between an electrified vehicle and a battery trailer according to the embodiment;

FIG. 4 shows details of the battery rental system according to the embodiment;

FIG. 5 is a block diagram showing functional features of a control device according to the embodiment;

FIG. 6 shows control of an estimation unit of the control device according to the embodiment;

FIG. 7 is a flowchart showing processing in the battery rental system according to the embodiment;

FIG. 8 shows a first modification of locations where rental stores are installed;

FIG. 9 illustrates a second modification of locations where rental stores are installed; and

FIG. 10 illustrates an electrified vehicle equipped with a battery device according to a modification of the embodiment.

### DETAILED DESCRIPTION OF EMBODIMENTS

An embodiment of the present disclosure will be described in detail below with reference to the drawings. The same or corresponding parts are denoted by the same signs throughout the drawings, and description thereof will not be repeated.

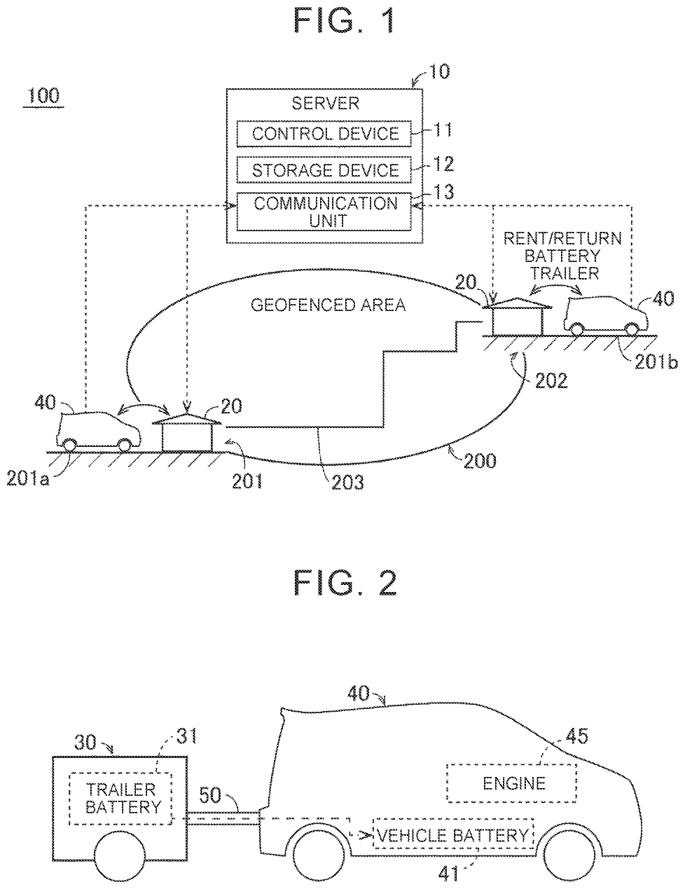

FIG. 1 shows a battery rental system 100 according to the present embodiment. The battery rental system 100 includes a server 10, a rental store 20, and an electrified vehicle 40. Although two rental stores 20 are shown in the example of FIG. 1, the number of rental stores 20 is not limited to two.

The rental store 20 rents a battery trailer 30 (see FIG. 2) to the electrified vehicle 40. The electrified vehicle 40 can rent and return the battery trailer 30 from and to the rental store 20.

The rental stores 20 are located at an entrance 201 of a geofenced area 200 (connecting major road 201a leading to the geofenced area 200) and an exit 202 of the geofenced area 200 (connecting major road 201b leading to the geofenced area 200). The “geofenced area 200” means a controlled area where exhaust emissions are controlled. The electrified vehicle 40 is a hybrid electric vehicle equipped with an engine 45 (see FIG. 2). The geofenced area 200 is an example of the “controlled area” in the present disclosure.

The server 10 includes a control device 11, a storage device 12, and a communication unit 13. The server 10 is a server that manages rental of the battery trailer 30 at the rental store 20. The communication unit 13 is an example of the “acquisition unit” in the present disclosure. The control device 11 is a processor in the server 10.

As shown in FIG. 2, the battery trailer 30 includes a trailer battery 31 having a predetermined remaining capacity. The battery trailer 30 is towable by the electrified vehicle 40 with the battery trailer 30 connected thereto by a connecting portion 50. The battery trailer 30 (trailer battery 31) is an example of the “battery” in the present disclosure.

The power of the trailer battery 31 is sent to a vehicle battery 41 of the electrified vehicle 40 via the connecting portion 50. The sum of the remaining capacity of the vehicle battery 41 of the electrified vehicle 40 and the remaining capacity of the trailer battery 31 is therefore available for the electrified vehicle 40 to travel.

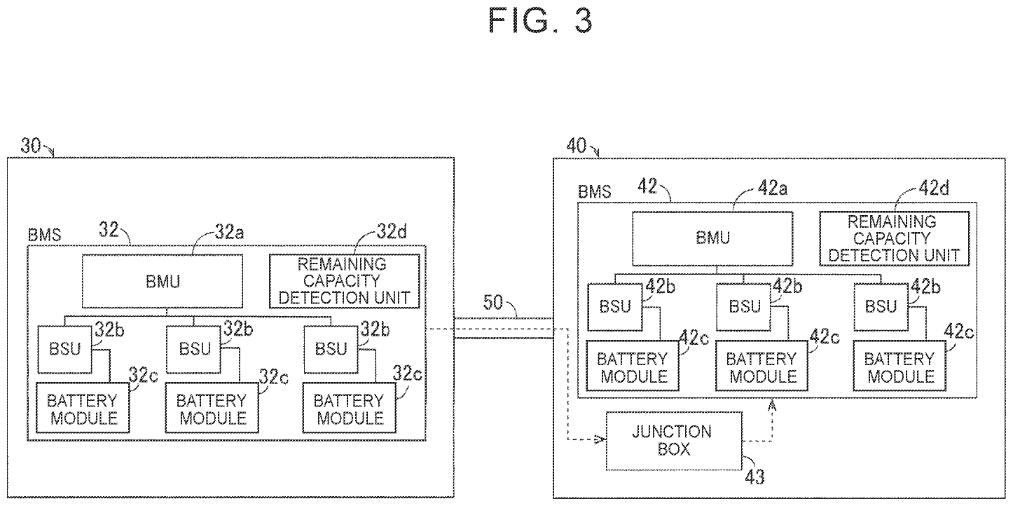

FIG. 3 shows a specific example. The battery trailer 30 includes a battery management system (BMS) 32. The BMS 32 includes a battery management unit (BMU) 32a, a plurality of battery support units (BSUs) 32b, a plurality of battery modules 32c, and a remaining capacity detection unit 32d. The battery modules 32c form the trailer battery 31 (see FIG. 2).

The BMU 32a monitors a current value in the BMS 32 to control communication with a host controller, store logs, etc. The BMU 32b monitors the state (voltage, temperature, etc.) of the battery module 32c and supplies power to the BMU 32a. The remaining capacity detection unit 32d detects the remaining capacities of the battery modules 32c (trailer battery 31) and sends information on the detected remaining capacities to the communication unit 13 of the server 10 (see FIG. 1).

The electrified vehicle 40 includes a BMS 42. The BMS 42 includes a BMU 42a, a plurality of BSUs 42b, a plurality of battery modules 42c, and a remaining capacity detection unit 42d. The battery modules 42c form the vehicle battery 41 (see FIG. 2). Since the BMS 42 has a configuration similar to the BMS 32, detailed description of the functions of the BMS 42 will be omitted.

The electrified vehicle 40 further includes a junction box 43. The power from the battery trailer 30 is supplied to the BMS 42 via the junction box 43. The junction box 43 includes a power converter (inverter) that converts the power from the battery trailer 30 (BMS 32) to appropriate power (voltage).

The configurations of the battery trailer 30 and electrified vehicle 40 shown in FIG. 3 are merely illustrative, and the battery trailer 30 and the electrified vehicle 40 may have other configurations. For example, only one of the battery trailer 30 and the electrified vehicle 40 may be provided with a BMS. In this case, the other of the battery trailer 30 and the electrified vehicle 40 may be provided with battery modules, but may not be provided with a BMU, BSUs, a remaining capacity detection unit, etc.

Referring back to FIG. 1, the storage device 12 stores programs to be executed by the control device 11 and information to be used in the programs (e.g., maps, mathematical expressions, and various parameters). The communication unit 13 includes various communication interfaces (I/Fs). The control device 11 controls the communication unit 13.

As shown in FIG. 1, the server 10 (communication unit 13) is configured to communicate with each of a plurality of electrified vehicles 40. The communication unit 13 is configured to communicate with (a server etc., not shown, of) each rental store 20.

As shown in FIG. 4, the communication unit 13 acquires information on the state etc. of the electrified vehicle 40 from each electrified vehicle 40. For example, the communication unit 13 acquires information on the state of charge (SOC) of the electrified vehicle 40. The communication unit 13 also acquires information on the destination of the electrified vehicle 40 (distance to the destination, etc.). The communication unit 13 also acquires information on the vehicle state of the electrified vehicle 40 (e.g., information on the carried load weight). The information on the destination and the information on the vehicle state are sent from the electrified vehicle 40 to the communication unit 13 when the electrified vehicle 40 is started, or are sent from a user's mobile terminal etc. to the communication unit 13 before the electrified vehicle 40 travels.

The communication unit 13 also acquires information on the traffic conditions, road surface conditions, weather, temperature, etc. on the Internet.

The communication unit 13 acquires from the rental store 20 information on battery trailers 30 that are available for rent. The communication unit 13 also acquires information on the remaining capacities of those available battery trailers 30. In the example of FIG. 4, the communication unit 13 acquires information indicating that battery trailers 30A to 30C are available for rent and that the remaining capacities of the battery trailers 30A to 30C are 100 kWh, 200 kWh, and 300 kWh, respectively.

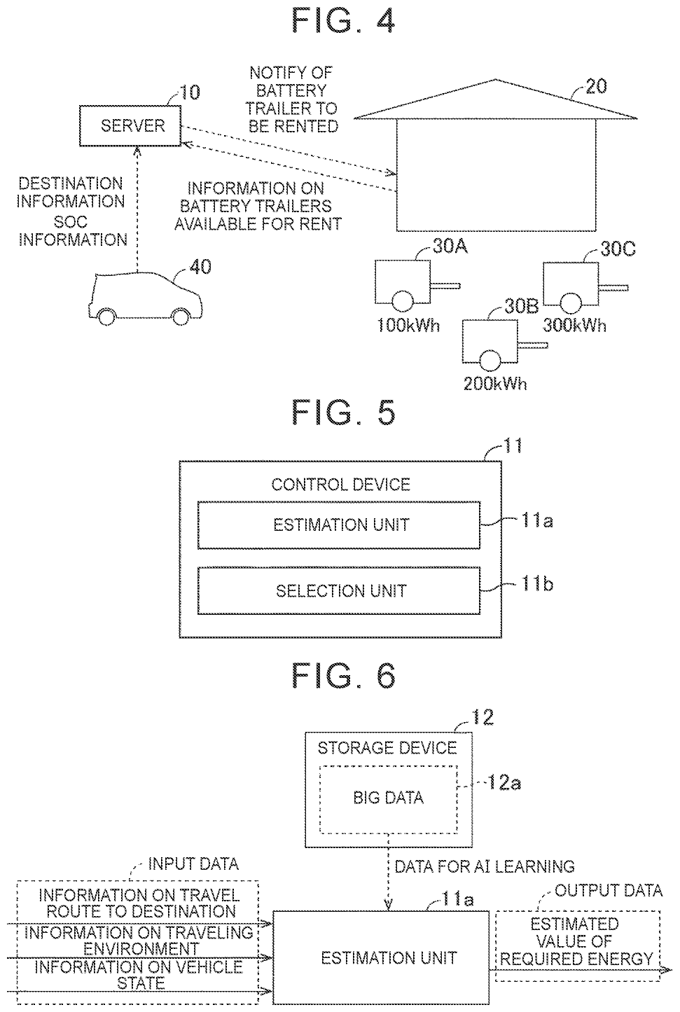

As shown in FIG. 5, the control device 11 of the server 10 includes an estimation unit 11a and a selection unit 11b. Each of the estimation unit 11a and the selection unit 11b represents software, showing the functional features of the control device 11 as blocks.

As shown in FIG. 6, the storage device 12 of the server 10 stores big data 12a that is a collection of a plurality of pieces of data. These pieces of data are data on the relationship between the traveling state and traveling environment of the electrified vehicle 40 and the power required for traveling. The traveling state includes, for example, vehicle speed, carried load weight, and vehicle state (e.g., tire pressures). The traveling environment includes road conditions, traffic conditions, and weather (temperature). The big data 12a is formed by collecting the above data sent from each electrified vehicle 40 in the server 10 (storage device 12).

The control device 11 (estimation unit 11a) estimates the energy required for the electrified vehicle 40 to reach the destination. The control device 11 (estimation unit 11a) uses the big data 12a stored in the storage device 12 to estimate the energy required for the electrified vehicle 40 to reach the destination.

The control device 11 (estimation unit 11a) herein uses artificial intelligence (AI) learned based on the big data 12a to estimate the energy required for the electrified vehicle 40 to reach the destination. The control device 11 (estimation unit 11a) learned by using a plurality of pieces of data on the relationship between the traveling state and traveling environment of the electrified vehicle 40 and the power required for traveling as data for learning.

The control device 11 (estimation unit 11a) receives the following information as input data: information on a travel route to the destination (distance, road conditions (roughness, number of slopes, etc.), traffic conditions, etc.), information on the traveling environment (temperature, weather, etc.), and information on the vehicle state (carried load weight, tire pressures, etc.). The control device 11 (estimation unit 11a) then outputs an estimated value of the required energy based on the above learning results.

In conventional battery rental systems, there are cases where a battery trailer 30 whose remaining capacity is too large for the energy required for the electrified vehicle 40 is rented. It is therefore desired to rent a battery trailer 30 whose remaining capacity is appropriate for the energy required for the electrified vehicle 40.

In the present embodiment, the control device 11 (selection unit 11b, see FIG. 5) selects a battery trailer 30 to be rented to the electrified vehicle 40 from the battery trailers 30 based on the required energy estimated by the estimation unit 11a.

This will be specifically described with reference to FIG. 4. It is herein assumed that the required energy estimated by the estimation unit 11a is 250 kWh and that the current SOC of the electrified vehicle 40 is 70 kWh. In this case, the electrified vehicle 40 can reach the destination regardless of whether the battery trailer 30B or the battery trailer 30C is selected. In this case, the control device 11 (selection unit 11b) selects the battery trailer 30B with a smaller remaining capacity. In other words, the control device 11 (selection unit 11b) selects a battery trailer 30 with the smallest remaining capacity from the battery trailers 30 with which the electrified vehicle 40 can reach the destination. The communication unit 13 then notifies the rental store 20 that the battery trailer 30B has been selected. In this example, the battery trailer 30B and the battery trailer 30C are examples of the “first battery” and the “second battery” in the present disclosure, respectively.

An example will be specifically described in which the destination of the electrified vehicle 40 is the exit 202 (see FIG. 1) of the geofenced area 200 and a battery trailer 30 is rented to the electrified vehicle 40 at the entrance 201 (see FIG. 1) of the geofenced area 200. In this case, the control device 11 (estimation unit 11a) calculates a travel route 203 that requires less power consumption out of a plurality of travel routes to the destination (exit 202), based on the big data 12a. The control device 11 (estimation unit 11a) then estimates the required energy when the electrified vehicle 40 travels along the travel route 203.

Specifically, the control device 11 (estimation unit 11a) uses the artificial intelligence (AI) learned based on the big data 12a to calculate the travel route 203 that requires the lowest power consumption among the travel routes to the destination. More specifically, the control device 11 (estimation unit 11a) refers to the distance, road conditions (roughness, number of slopes, etc.), traffic conditions, etc. of each travel route to estimate power consumption when the electrified vehicle 40 travels along each travel route. The control device 11 (estimation unit 11a) thus calculates the travel route 203 that requires the lowest power consumption. Based on the estimated required energy, the control device 11 (selection unit 11b) selects a battery trailer 30 to be rented to the electrified vehicle 40 from the battery trailers 30 that are available for rent at the rental store 20 located at the entrance 201.

The cost of renting the battery trailer 30 may be determined based on the rental period of the battery trailer 30, the energy consumed, the initial remaining capacity of the battery trailer 30, etc.

Control Flow of Server

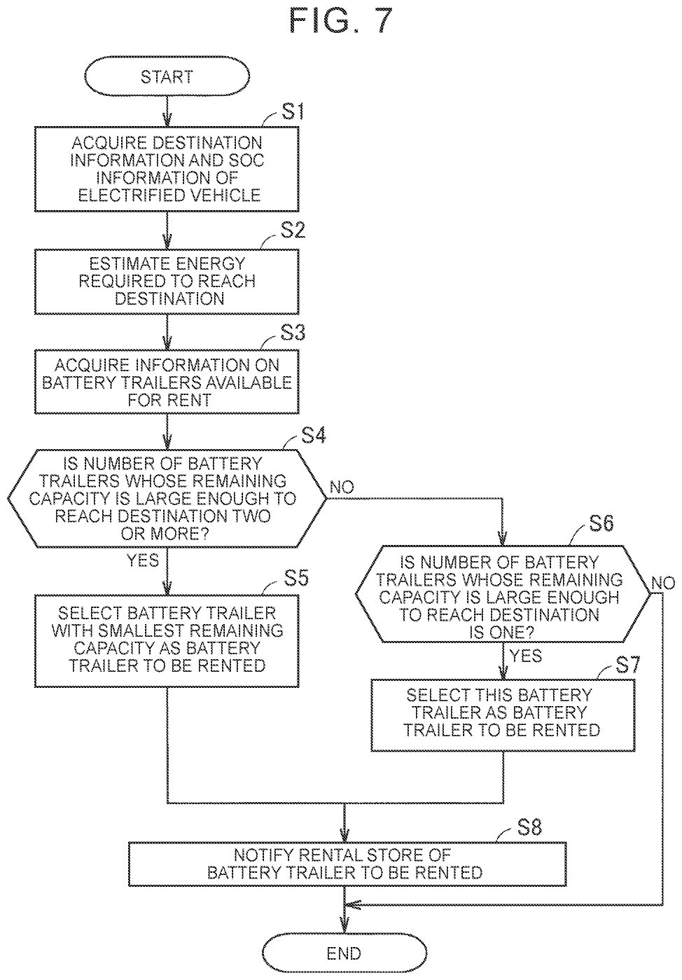

Next, a control flow for selecting a battery trailer 30 by the server 10 will be described with reference to FIG. 7.

First, in step S1, the server 10 (communication unit 13) acquires information on the destination of the electrified vehicle 40 and information on the SOC of the electrified vehicle 40. In step S1, the server 10 (communication unit 13) also acquires information such as the vehicle state of the electrified vehicle 40, traffic conditions, road surface conditions, weather, and temperature.

Next, in step S2, the control device 11 (estimation unit 11a) of the server 10 estimates the energy required for the electrified vehicle 40 to reach the destination, based on the information acquired in step S1. In step S2, as described above, the required energy is estimated using the artificial intelligence (AI) learned from the big data 12a stored in the storage device 12.

In step S3, the server 10 (communication unit 13) then acquires, from the rental store 20, information on battery trailers 30 that are available for rent. At this time, the server 10 (communication unit 13) also acquires information on the remaining capacities of these available battery trailers 30. Step S3 may be performed before, or at the same time as, steps S1 and S2.

Thereafter, in step S4, the control device 11 (selection unit 11b) determines, based on the information acquired in step S3, whether the number of battery trailers 30 available for rent is two or more. When the number of battery trailers 30 available for rent is two or more (Yes in S4), the process proceeds to step S5. When the number of battery trailers 30 available for rent is not two or more (No in S4), the process proceeds to step S6.

In step S5, the control device 11 (selection unit 11b) selects a battery trailer 30 with the smallest remaining capacity from the available battery trailers 30 as a battery trailer 30 to be rented to the electrified vehicle 40. The process then proceeds to step S8.

In step S6, the control device 11 (selection unit 11b) determines whether the number of battery trailers 30 available for rent is one. When the number of battery trailers 30 available for rent is one (Yes in S6), the process proceeds to step S7. The process ends when the number of battery trailers 30 available for rent is not one (when the number of battery trailers 30 available for rent is zero) (No in S6).

In step S7, the control device 11 (selection unit 11b) selects this one available battery trailer 30 as a battery trailer 30 to be rented to the electrified vehicle 40. The process then proceeds to step S8.

In step S8, the server 10 (communication unit 13) notifies the rental store 20 of the battery trailer 30 to be rented to the electrified vehicle 40. The process then ends.

As described above, in the present embodiment, the control device 11 includes: the estimation unit 11a that estimates the energy required for the electrified vehicle 40 to reach the destination; and the selection unit 11b that selects a battery trailer 30 to be rented to the electrified vehicle 40 from the battery trailers 30. With this configuration, a battery trailer 30 with a relatively large remaining capacity is less likely to be selected from the battery trailers 30 whose remaining capacity is large enough for the energy required for the electrified vehicle 40 to reach the destination.

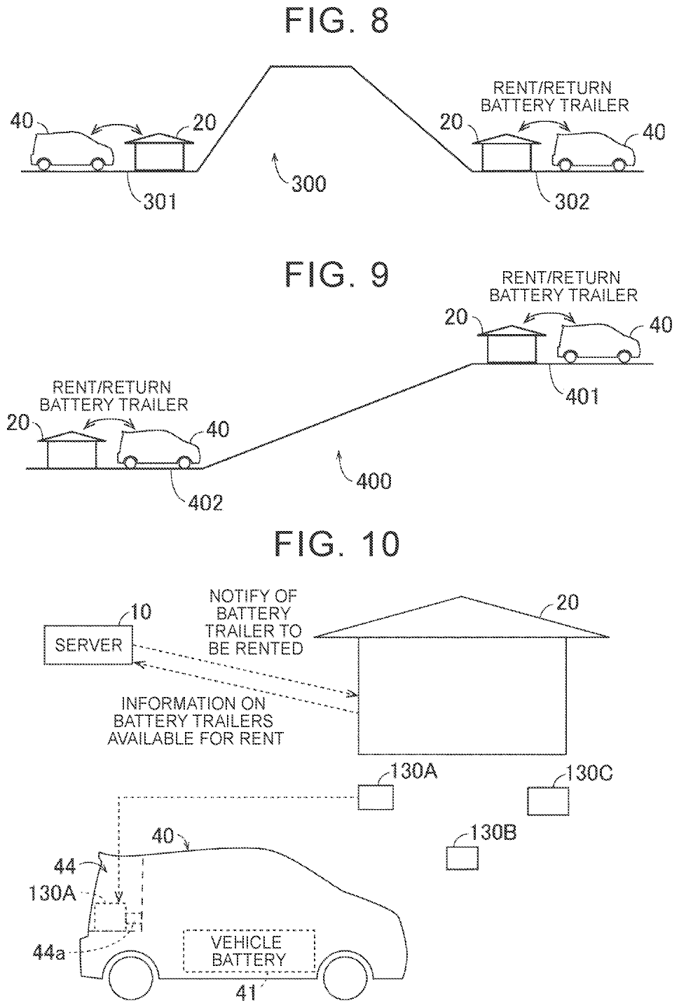

The above embodiment illustrates an example in which the rental stores 20 are located at the entrance 201 and exit 202 of the geofenced area 200. However, the present disclosure is not limited to this. As shown in FIG. 8, the rental stores 20 may be located at a foot 301 of a hill road 300 and the opposite foot 302 of the hill road 300 from the foot 301. Since regenerative energy is generated as the electrified vehicle 40 travels downhill, the need for charging at the foot 301 or the foot 302 can be reduced. Such generation of the regenerative energy can also reduce the load on the engine 45. When the battery trailer 30 has such a charging capacity that the battery trailer 30 can be fully charged by the regenerative energy, the need for charging at the rental store 20 is reduced. Therefore, the need to install charging equipment at the rental store 20 is reduced.

As shown in FIG. 9, the rental stores 20 may be located at the entrance and exit of a slope 400 connecting a highland 401 and a lowland 402. That is, the rental stores 20 are located in the highland 401 and the lowland 402. The rental store 20 in the highland 401 may rent a battery trailer 30 at a discounted price on the condition that the battery trailer 30 charged by the regenerative energy will be returned to the rental store 20 in the lowland 402.

The above embodiment illustrates an example in which the control device 11 (selection unit 11b) selects a battery trailer 30 to be connected to the electrified vehicle 40. However, the present disclosure is not limited to this. As shown in FIG. 10, a battery device that can be loaded on the electrified vehicle 40 may be selected. FIG. 10 shows an example in which a battery device 130A is selected from battery devices 130A to 130C that are available for rent at the rental store 20. The battery devices 130A to 130C are loaded on, for example, a trunk 44 of the electrified vehicle 40. The battery devices 130A to 130C are electrically connected to the electrified vehicle 40 (vehicle battery 41) in the trunk 44 by a connecting portion 44a. The battery devices 130A to 130C are examples of the “battery” in the present disclosure.

The above embodiment illustrates an example in which the control device 11 estimates the energy required to reach the destination and selects a battery trailer 30. However, the present disclosure is not limited to this. In addition to the control described above, the control device may perform, for example, control to inform the user of candidate rental stores 20 from which he or she should rent a battery trailer 30.

The above embodiment illustrates an example in which the control device 11 of the server 10 installed separately from the rental stores 20 estimates the energy required to reach the destination and selects a battery trailer 30. However, the present disclosure is not limited to this. For example, a server installed at each rental store 20 may perform the above control.

Alternatively, a control device mounted on the electrified vehicle 40 may perform the above control. In this case, information on the battery trailers 30 that are available for rent is sent from the rental store 20 to the electrified vehicle 40, and the electrified vehicle 40 selects a battery trailer 30 based on this information. An app for using the big data 12a may be usable by, for example, the electrified vehicle 40 or the user's mobile terminal.

The above embodiment illustrates an example in which the battery trailer 30 is towed by the electrified vehicle 40. However, the present disclosure is not limited to this. A battery trailer may be self-propelled.

The embodiment disclosed herein shall be construed as illustrative in all respect and not restrictive. The scope of the present disclosure is shown by the claims rather than by the above description of the embodiment, and is intended to include all modifications within the meaning and scope equivalent to those of the claims.

What is claimed is:

1. A battery rental system for renting to an electrified vehicle at least one of a plurality of batteries that supplies power to the electrified vehicle, the battery rental system comprising:
an acquisition unit that acquires information on a destination of the electrified vehicle;
an estimation unit that estimates energy required for the electrified vehicle to reach the destination; and
a selection unit that selects a battery to be rented to the electrified vehicle from the plurality of batteries based on the estimated required energy.

2. The battery rental system according to claim 1, wherein:
the plurality of batteries include a first battery and a second battery;
a sum of a remaining capacity of the electrified vehicle and a remaining capacity of the first battery is equal to or larger than the required energy;
the second battery has a larger remaining capacity than the first battery; and
the selection unit selects the first battery as the battery to be rented to the electrified vehicle when the first battery and the second battery are available for rent.

3. The battery rental system according to claim 1, wherein the estimation unit estimates the required energy based on at least a travel route to the destination by using big data, the big data being a collection of a plurality of pieces of data on a relationship between a traveling state and traveling environment of the electrified vehicle and power required for traveling.

4. The battery rental system according to claim 3, wherein the estimation unit calculates the travel route to the destination that requires less power consumption based on the big data, and estimates the required energy when the electrified vehicle travels along the travel route that requires less power consumption.

5. The battery rental system according to claim 1, wherein:
the electrified vehicle includes a hybrid electric vehicle equipped with an engine;
the destination includes an exit of a controlled area where exhaust emissions are controlled;
the estimation unit estimates energy required for the electrified vehicle to travel along a travel route from an entrance of the controlled area to the exit of the controlled area; and
the selection unit selects, based on the estimated required energy, the plurality of battery to be rented to the electrified vehicle from the batteries that are available for rent at the entrance.

6. The battery rental system according to claim 1, wherein the selection unit selects at least one of a plurality of self-propelled or towable battery trailers based on the estimated required energy.

7. The battery rental system according to claim 1, wherein the selection unit selects, based on the estimated required energy, at least one of a plurality of battery devices configured to be loaded on the electrified vehicle.

8. A battery rental method for renting to an electrified vehicle at least one of a plurality of batteries that supplies power to the electrified vehicle, the battery rental method comprising:
acquiring information on a destination of the electrified vehicle;
estimating energy required for the electrified vehicle to reach the destination; and
selecting a plurality of battery to be rented to the electrified vehicle from the batteries based on the estimated required energy.

9. A non-transitory storage medium storing instructions that are executable by one or more processors of a server configured to communicate with each of a plurality of electrified vehicles and that cause the one or more processors to perform functions comprising:
acquiring information on a destination of the electrified vehicle;
estimating energy required for the electrified vehicle to reach the destination; and
selecting a battery to be rented to the electrified vehicle from a plurality of batteries based on the estimated required energy.
